(19) United States
(12) Patent Application Publication
(10) Pub. No.: US 2016/0188852 A1
(43) Pub. Date: Jun. 30, 2016

(54) ELECTRONIC DEVICE AND UNLOCKING METHOD THEREOF

(71) Applicant: HON HAI PRECISION INDUSTRY CO., LTD., New Taipei (TW)

(72) Inventor: CHIH-HUA HSU, New Taipei (TW)

(21) Appl. No.: 14/797,636

(22) Filed: Jul. 13, 2015

(30) Foreign Application Priority Data
Dec. 27, 2014 (CN) 201410825161.4

(51) Int. Cl. G06F 21/31; G06F 3/0488; G06K 9/00; G06F 3/041

(52) U.S. Cl. CPC G06F 21/31; G06F 3/0412; G06F 3/0416; G06F 3/0488; G06K 9/00436; G06F 2203/04104; G06F 2203/04808

(57) ABSTRACT

An unlocking method of electronic device includes controlling a display device to display an unlocking interface which includes an input area. Information of one or more input traces is received in response to a series of touch operations applied to the input area. Shapes of the one or more input traces are determined, and whether the shapes of the one or more input traces match predetermined shapes of multiple preset traces which are pre-stored in a storage device. The electronic device is unlocked if the shapes of the one or more input traces match the predetermined shapes of the multiple preset traces.

### CROSS-REFERENCE TO RELATED APPLICATIONS

This application claims priority to Chinese Patent Application No. 201410825161.4 filed on Dec. 27, 2014, the contents of which are incorporated by reference herein.

### FIELD

The subject matter herein generally relates to an electronic device and an unlocking method thereof.

### BACKGROUND

Screen locks are set to protect privacy information stored in electronic devices. Pattern locking is a popular convenient way to lock.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including an unlocking system.

FIG. 2 illustrates a diagrammatic view of one embodiment of an unlocking interface displayed on the electronic device of FIG. 1.

FIG. 3 illustrates a diagrammatic view of one embodiment of an input pattern displayed on the electronic device of FIG. 1.

FIG. 4 illustrates a diagrammatic view of one embodiment of a main interface displayed on the electronic device of FIG. 1.

FIG. 5 illustrates a diagrammatic view of one embodiment of a prompt interface displayed on the electronic device of FIG. 1 for prompting an unlocking fail.

FIG. 6 illustrates a flowchart of one embodiment of an unlocking method for the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in details so as not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media includes CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

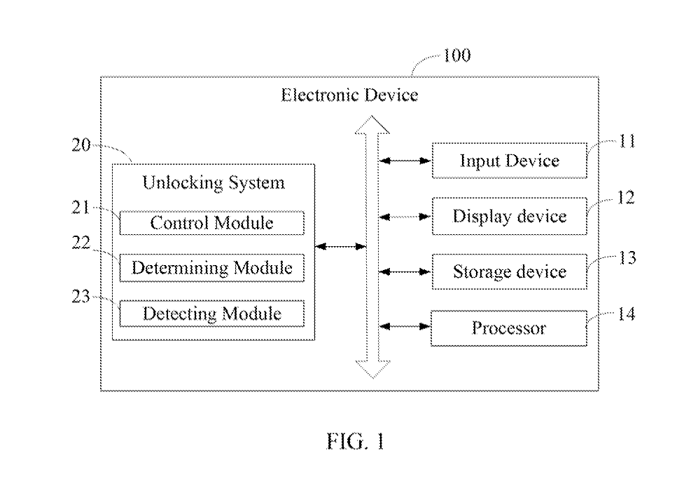

FIG. 1 illustrates a block diagram of one embodiment of an electronic device 100. In at least one embodiment as shown in FIG. 1, the electronic device 100 includes, but is not limited to, an unlocking system 20, an input device 11, a display device 12, a storage device 13 and at least one processor 14. The electronic device 100 can be a tablet computer, a notebook computer, a smart phone, a personal digital assistant (PDA), or another suitable electronic device. FIG. 1 illustrates only one example of the electronic device 100 that can include more or fewer components than illustrated, or have a different configuration of the various components in other embodiments.

The input device 11 can receive an applied input, and the display device 12 can display a user interface of the electronic device 100. In at least one embodiment, the input device 11 and the display device 12 are combined as a touch screen.

The storage device 13 can pre-store unlocking information for unlocking the electronic device 100. The unlocking information includes information associated with multiple preset traces each having a predetermined shape, a predetermined input order of the multiple preset traces, relative size of the multiple preset traces and relative position of the multiple preset traces. In at least one embodiment, the storage device 13 can include various types of non-transitory computer-readable storage mediums. For example, the storage device 13 can be an internal storage system, such as a flash memory, a random access memory (RAM) for temporary storage of information, and/or a read-only memory (ROM) for permanent storage of information. The storage device 13 can also be an external system, such as a hard disk, a storage card, or a data storage medium. The at least one processor 14 can be a central processing unit (CPU), a microprocessor, or other data processor chip that performs functions of the unlocking system 10 in the electronic device 100.

The unlocking system 20 can compare information of one or more input traces to pre-stored unlocking information of multiple preset traces, and unlock the electronic device 100 when the shapes and input order of the one or more input traces match that of the multiple preset traces.

In at least one embodiment, the unlocking system 20 can include a control module 21, a determining module 22 and a detecting module 23. The function modules 21-23 can include computerized codes in the form of one or more programs, which are stored in the storage device 13. The at least one processor 14 executes the computerized codes to provide functions of the function modules 21-23.

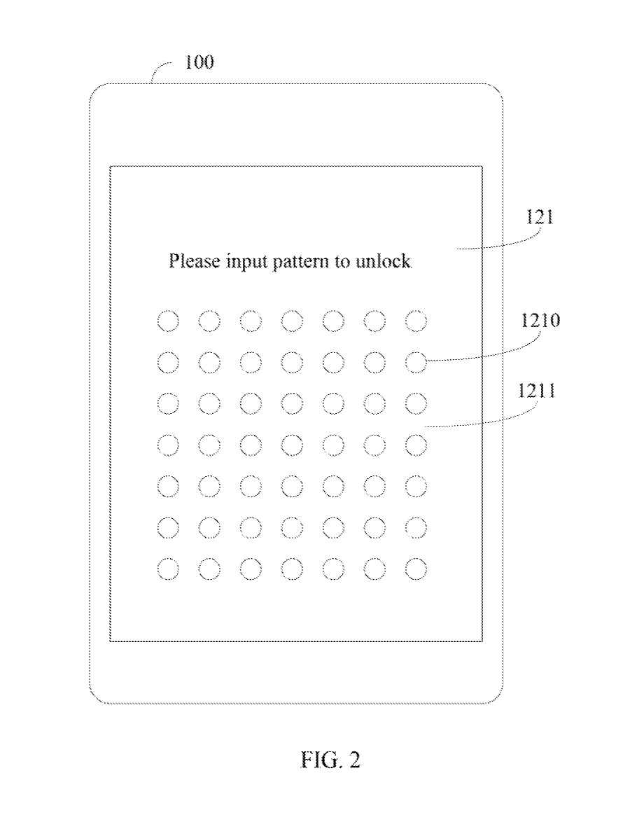

FIG. 2 illustrates the control module 21 controls the display device 12 to display an unlocking interface 121 which includes an input area. In at least one embodiment, the input area is a rectangular array 1211 of a number of circles 1210, and the user can input traces on the rectangular array 1211. In other embodiments, the input area can be replaced by a blank area, and the user can input traces in the blank area.

The determining module 22 receives, in response to a series of touch operations applied to the input area through the input device 11, information of one or more input traces. In at least one embodiment, the detecting module 23 detects a touch operation applied to the input area through the input device 11, and the determining module 22 determines whether there is another touch operation applied to the input area within a preset time. If there is another touch operation applied to the input area within the preset time, the detecting module 23 continually detects the touch operation applied to the input area. If there is no touch operation applied to the input area within the preset time, the detecting module 23 ends the detection and the determining module 22 receives information of the one or more input traces according to the detected touch operations.

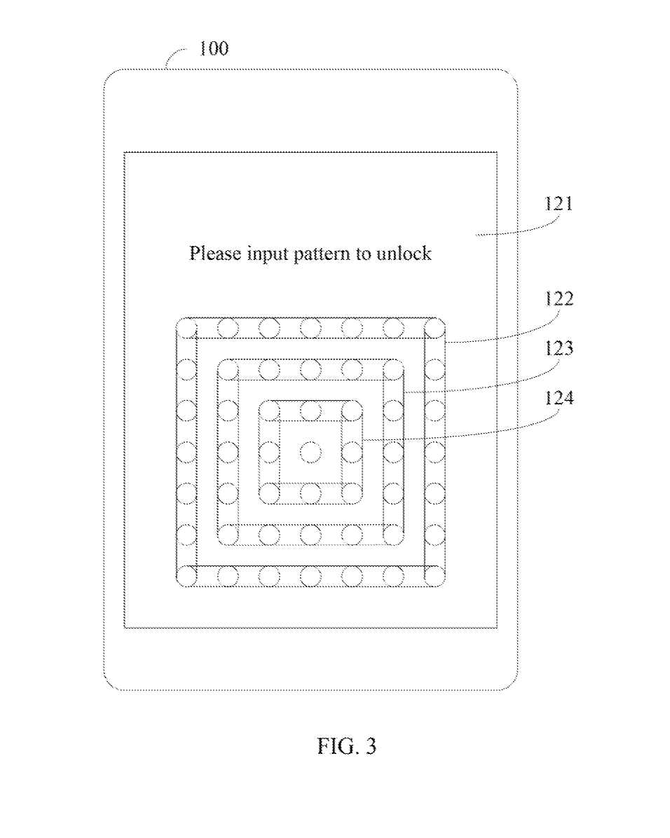

For example, with reference to FIG. 3, presuming that the detecting module 23 has detected a first touch operation which forms a first trace 122, the determining module 22 determines there is a second touch operation applied to the input area within the preset time, and the detecting module 23 detects the second touch operation which forms a second trace 123. The determining module 22 further determines whether there is a third touch operation applied to the input area within the preset time. If there is no third touch operation applied to the input area, the detecting module 23 ends the detection and the determining module 22 determines one or more input traces consisting of the first trace 122 and the second trace 123. If there is a third touch operation applied to the input area, the detecting module 23 continually detects the third touch operation which forms a third trace 124. And if there is no fourth touch operation applied to the input area, the determining module 22 determines one or more input traces consisting of the first trace 122, the second trace 123 and the third trace 124.

The control module 21 controls the display device 12 to display the determined one or more input traces on the input area and the determining module 22 determines whether the information of the one or more input traces matches the unlocking information of the multiple preset traces. In some embodiments, the information of the one or more input traces includes shapes of the one or more input traces, an input order of the one or more input traces, relative size of the one or more input traces and relative position of the one or more input traces.

In at least one embodiment, the determining module 22 determines the information of the one or more input traces matches the unlocking information of the multiple preset traces if the shapes, input order, relative size and relative position of the one or more input traces all match that of the multiple preset traces and determines the information of the one or more input traces does not match the unlocking information of the multiple preset traces if one of the shapes, input order, relative size and relative position does not match that of the multiple preset traces.

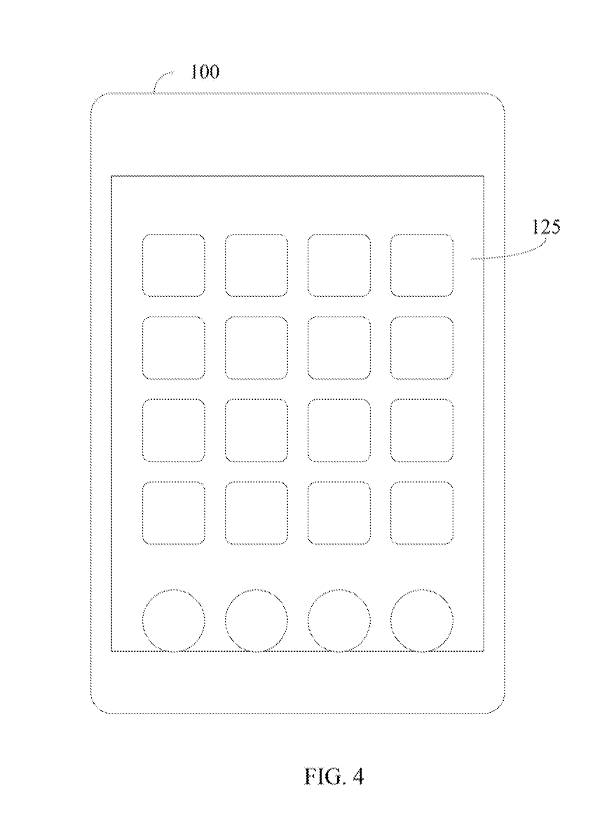

If the information of the one or more input traces matches the unlocking information of the multiple preset traces, the control module 21 unlocks the electronic device 100 and controls the display device 12 to display a main interface 125 (see FIG. 4) after unlocking the electronic device 100.

If the information of the one or more input traces does not match the unlocking information of the multiple preset traces, the control module 21 controls the display device 12 to display a prompt interface 126 for prompting an unlocking fail (see

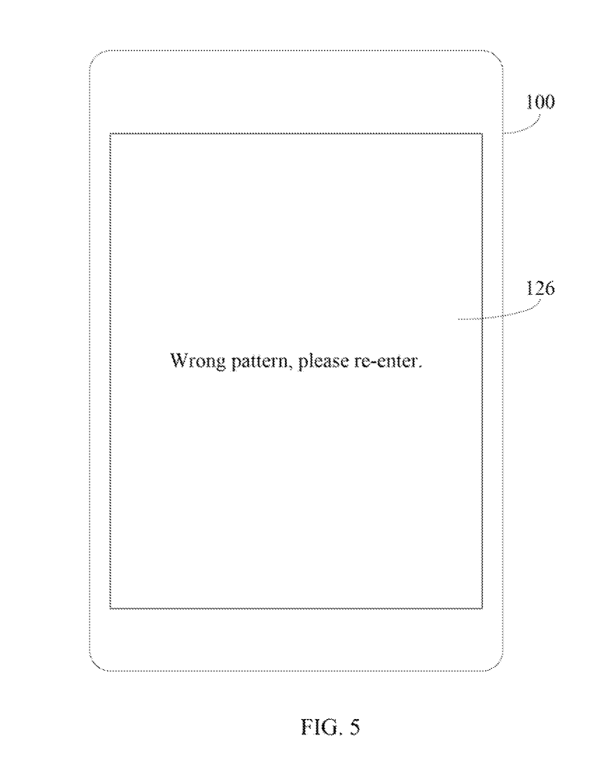

FIG. 5), and the control module 24 further controls the display device 12 to display the unlocking interface 121 few seconds later.

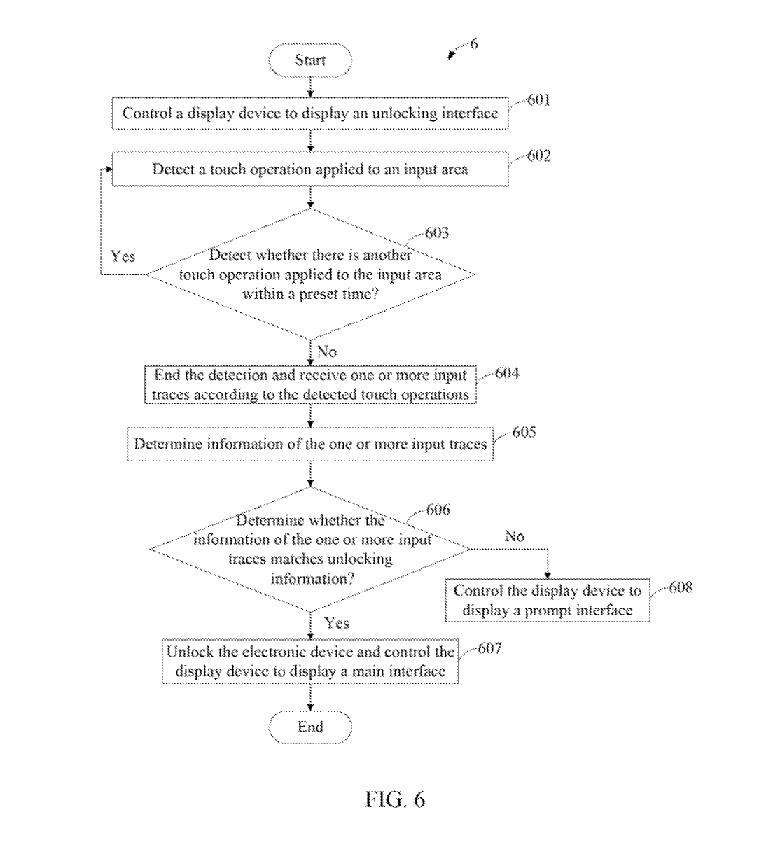

Referring to FIG. 6, a flowchart of an unlocking method of an electronic device is presented in accordance with an example embodiment. The example method 6 is provided by way of example, as there are a variety of ways to carry out the method. The example method 6 described below can be carried out using the configurations illustrated in FIG. 1 for example, and various elements of these figures are referenced in explaining example method 6. Each block shown in FIG. 6 represents one or more processes, methods, or subroutines carried out in the example method 6. Furthermore, the illustrated order of blocks is by example only and the order of the blocks can be changed. The example method 6 can begin at block 601. Depending on the embodiment, additional steps can be added, others removed, and the ordering of the steps can be changed.

At block 601, a control module controls a display device to display an unlocking interface which includes an input area.

At block 602, a detecting module detects a touch operation applied to the input area through an input device.

At block 603, the detecting module detects whether there is another touch operation applied to the input area within a preset time. If there is another touch operation applied to the input area within the preset time, block 602 is implemented.

Otherwise, if there is no touch operation applied to the input area within the preset time, block 604 is implemented.

At block 604, the detecting module ends the detection and a determining module receives one or more input traces according to the detected touch operations.

At block 605, the determining module determines information of the one or more input traces and the control module controls the display device to display the one or more input traces on the input area.

At block 606, the determining module determines whether the information of the one or more input traces matches the unlocking information of multiple preset traces pre-stored in a storage device. If the information of the one or more input traces matches the unlocking information of multiple preset traces, block 607 is implemented. Otherwise, if the information of the one or more input traces does not match the unlocking information of multiple preset traces, block 608 is implemented.

At block 607, the control module unlocks the electronic device and controls the display device to display a main interface of the electronic device after unlocking the electronic device.

At block 608, the control module controls the display device to display a prompt interface for prompting an unlocking fail and display the unlocking interface few seconds later.

With such a configuration, the shapes and input order of one or more input traces must match that of the multiple preset traces, and then the electronic device will be unlocked.

It should be emphasized that above-described embodiment of the present disclosure including any particular embodiments, are merely examples of implementations set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
an input device;
at least one processor coupled to the input device;
a display device coupled to the at least one processor; and
a non-transitory storage device that pre-stores unlocking information for unlocking the electronic device, wherein the unlocking information comprises information associated with multiple preset traces each having a predetermined shape, and the storage device further stores one or more programs which, when executed by the at least one processor, cause the at least one processor to:
control the display device to display an unlocking interface which comprises an input area;
receive, in response to a series of touch operations applied to the input area through the input device, information of one or more input traces;
determine one or more shapes corresponding to the one or more input traces;
determine that one or more shapes match one or more predetermined shapes of the multiple preset traces; and
unlock, in response to determining that the one or more shapes match the one or more predetermined shapes of the multiple preset traces, the electronic device.

2. The electronic device according to claim 1, wherein the unlocking information further comprises a predetermined input order of the multiple preset traces, and the at least one processor further:
determines an input order of the one or more input traces, and determines that the input order of the one or more input traces matches the predetermined input order of the multiple preset traces; and
upon such determination, unlocks the electronic device.

3. The electronic device according to claim 1, wherein the unlocking information further comprises relative size of the multiple preset traces or relative position of the multiple preset traces.

4. The electronic device according to claim 1, wherein the at least one processor further:
determines that the shapes of the one or more input traces do not match the predetermined shapes of the multiple preset traces; and
upon such determination, controls the display device to display a prompt interface for prompting an unlocking fail.

5. The electronic device according to claim 4, wherein the at least one processor further controls the display device to display the unlocking interface few seconds later.

6. The electronic device according to claim 1, wherein the at least one processor receives, in response to a series of touch operations applied to the input area through the input device, information of one or more input traces by:
detecting a touch operation applied to the input area through the input device;
determining that there is another touch operation applied to the input area within a preset time;
upon such determination, continually detecting the touch operation applied to the input area;
determining that there is no touch operation applied to the input area within the preset time; and
upon such determination, ending the detection and receiving information of the one or more input traces according to the detected touch operations.

7. The electronic device according to claim 1, wherein the at least one processor further controls the display to display the determined one or more input traces on the input area.

8. The electronic device according to claim 1, wherein the input device and the display device are combined as a touch screen.

9. A computer-implemented unlocking method of an electronic device being executed by a processor of the electronic device, the method comprising:
controlling a display device of the electronic device to display an unlocking interface which comprises an input area;
receiving, in response to a series of touch operations applied to the input area through an input device of the electronic device, information of one or more input traces;
determining one or more shapes corresponding to the one or more input traces;
determining that one or more shapes match one or more predetermined shapes of multiple preset traces which are pre-stored in a storage device of the electronic device; and
unlock, in response to determining that the one or more shapes match the one or more predetermined shapes of the multiple preset traces, the electronic device.

10. The method according to claim 9, further comprising:
determining an input order of the one or more input traces, and determining that the input order of the one or more input traces matches a predetermined input order of the multiple preset traces which is pre-stored in the storage device; and
upon such determination, unlocking the electronic device.

11. The method according to claim 9, further comprising:
controlling the display device to display a main interface after unlocking the electronic device.

12. The method according to claim 9, further comprising:
determining that the shapes of the one or more input traces do not match the predetermined shapes of the multiple preset traces; and
upon such determination, controlling the display device to display a prompt interface for prompting an unlocking fail.

13. The method according to claim 12, further comprising:
controlling the display device to display the unlocking interface few seconds later.

14. The method according to claim 9, wherein receiving, in response to a series of touch operations applied to the input area through an input device of the electronic device, information of one or more input traces comprising:
detecting a touch operation applied to the input area through the input device;
determining that there is another touch operation applied to the input area within a preset time;
upon such determination, continually detecting the touch operation applied to the input area;
determining that there is no touch operation applied to the input area within the preset time; and
upon such determination, ending the detection and receiving information of the one or more input traces according to the detected touch operations.

15. A non-transitory storage medium having stored thereon instructions that, when executed by a processor of an electronic device, causes the processor to perform an unlocking method, the method comprising:
controlling a display device of the electronic device to display an unlocking interface which comprises an input area;
receiving, in response to a series of touch operations applied to the input area through an input device of the electronic device, information of one or more input traces;
determining one or more shapes corresponding to the one or more input traces;
determining that one or more shapes match one or more predetermined shapes of multiple preset traces which are pre-stored in a storage device of the electronic device; and
unlock, in response to determining that the one or more shapes match the one or more predetermined shapes of the multiple preset traces, the electronic device.

16. The non-transitory storage medium according to claim 15, wherein the method further comprising:
determining an input order of the one or more input traces, and determining that the input order of the one or more input traces matches a predetermined input order of the multiple preset traces which is pre-stored in the storage device; and
upon such determination, unlocking the electronic device.

17. The non-transitory storage medium according to claim 15, wherein the method further comprising:
controlling the display device to display a main interface after unlocking the electronic device.

18. The non-transitory storage medium according to claim 15, wherein the method further comprising:
determining that the shapes of the one or more input traces do not match the predetermined shapes of the multiple preset traces; and
upon such determination, controlling the display device to display a prompt interface for prompting an unlocking fail.

19. The non-transitory storage medium according to claim 18, wherein the method further comprising:
controlling the display device to display the unlocking interface few seconds later.

20. The non-transitory storage medium according to claim 15, wherein receiving, in response to a series of touch operations applied to the input area through an input device of the electronic device, information of one or more input traces comprising:
detecting a touch operation applied to the input area through the input device;
determining that there is another touch operation applied to the input area within a preset time;
upon such determination, continually detecting the touch operation applied to the input area;
determining that there is no touch operation applied to the input area within the preset time; and
upon such determination, ending the detection and receiving information of the one or more input traces according to the detected touch operations.
